(19) United States
(12) Patent Application Publication
(10) Pub. No.: US 2016/0306996 A1
(43) Pub. Date: Oct. 20, 2016

(54) SOCIAL DRIVE FOR SHARING DATA

(71) Applicant: McAfee, Inc., Santa Clara, CA (US)

(72) Inventors: Dattatraya Kulkarni, Bangalore (IN); Srikanth Nalluri, Bangalore (IN); Venkatasubrahmanyam Krishnapur, Bangalore (IN); Kaushal Dhruw, Bangalore (IN); Kamlesh Halder, Bangalore (IN); KranthiKumar Gadde, Bangalore (IN); Susmita Nayak, Fremont, CA (US); Mitesh Kumar, Bangalore (IN); Raj Vardhan, Ghaziabad (IN); Alan Illia Lefort, Cupertino, CA (US)

(73) Assignee: McAfee, Inc., Santa Clara, CA (US)

(21) Appl. No.: 15/101,527

(22) PCT Filed: Dec. 26, 2014
(86) PCT No.: PCT/US2014/072417

§ 371 Date: Jun. 3, 2016

(30) Foreign Application Priority Data
Jan. 3, 2014 (IN) 22/CHE/2014

(51) Int. Cl. G06F 21/62; G06F 17/30; H04L 29/06

(52) U.S. Cl. CPC G06F 21/6245; H04L 63/10; G06F 17/30864

(57) ABSTRACT

Particular embodiments described herein provide for an electronic device that can be configured to receive a request to share data, determine metadata for the data to be shared, communicate the metadata to a social drive, where the social drive is separate from the electronic device and the data is not located on the social drive, and communicate the shared data to a member of the social drive when the member requests the data.

### CROSS-REFERENCE TO RELATED APPLICATION

This application claims the benefit of priority to Indian Provisional Application Serial No. 22/CHE/2014, entitled “VIRTUAL SOCIAL DRIVE FOR SECURE SEAMLESS SHARING” filed 3 Jan. 2014 which is hereby incorporated by reference in its entirety.

### TECHNICAL FIELD

This disclosure relates in general to the field of data sharing, and more particularly, to a social drive for sharing data.

### BACKGROUND

The field of network security has become increasingly important in today's society. The Internet has enabled interconnection of different computer networks all over the world. In particular, the Internet provides a medium for exchanging data between different users connected to different computer networks via various types of client devices.

Several usage changes are rapidly transforming the consumer world propelled by smart devices in a variety of form factors. One is a device proliferation into many layers of society. Another is the rapidly increasing number of devices used in a family or household. Through one use, commonly referred to as sequential screening, users may use multiple devices, for example a smart phone, tablet, and notebook, between starting and finishing a task. There are many reasons for this emerging usage, including an availability of many devices around the house and at work place, user's physical proximity to a device, user's preference for certain applications and devices, ease of use of a specific device for a specific need, connectivity, etc. This is one motivation for storing browser history in the cloud so that the browsing activity on a device starts where the user left it on another device. This usage is expected to evolve as device capabilities expand and as consumers realize the possibilities. However, storing information in a cloud often limits the ability to share the data with others and if the data is shared with other, often the owner of the data does not retain control over the data.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which;

FIG. 1 is a simplified block diagram of a communication system for sharing data sing a social drive in accordance with an embodiment of the present disclosure;

FIG. 2 is a simplified block diagram of a portion of a communication system for sharing data using a social drive in accordance with an embodiment of the present disclosure;

FIG. 3 is a simplified block diagram of a portion of a communication system for sharing data using a social drive in accordance with an embodiment of the present disclosure;

FIG. 4 is a simplified block diagram of a portion of a communication system for sharing data using a social drive in accordance with an embodiment of the present disclosure;

FIG. 5A is a simplified block diagram of a portion of a communication system for sharing data using a social drive in accordance with an embodiment of the present disclosure;

FIG. 5B is a simplified block diagram of a portion of a communication system for sharing data using a social drive in accordance with an embodiment of the present disclosure;

FIG. 5C is a simplified block diagram of a portion of a communication system for sharing data using a social drive in accordance with an embodiment of the present disclosure;

FIG. 5D is a simplified block diagram of a portion of a communication system for sharing data using a social drive in accordance with an embodiment of the present disclosure;

FIG. 6A is a simplified block diagram of a portion of a communication system for sharing data using a social drive in accordance with an embodiment of the present disclosure;

FIG. 6B is a simplified block diagram of a portion of a communication system for sharing data using a social drive in accordance with an embodiment of the present disclosure;

FIG. 6C is a simplified block diagram of a portion of a communication system for sharing data using a social drive in accordance with an embodiment of the present disclosure;

FIG. 7 is a simplified flowchart illustrating potential operations that may be associated with the communication system in accordance with an embodiment;

FIG. 8 is a simplified flowchart illustrating potential operations that may be associated with the communication system in accordance with an embodiment;

FIG. 9 is a simplified flowchart illustrating potential operations that may be associated with the communication system in accordance with an embodiment;

FIG. 10 is a simplified flowchart illustrating potential operations that may be associated with the communication system in accordance with an embodiment;

FIG. 11 is a simplified time diagram illustrating possible example details associated with the communication system;

FIG. 12 is a simplified time diagram illustrating possible example details associated with the communication system;

FIG. 13 is a block diagram illustrating an example computing system that is arranged in a point-to-point configuration in accordance with an embodiment;

FIG. 14 is a simplified block diagram associated with an example ARM ecosystem system on chip (SOC) of the present disclosure; and

FIG. 15 is a block diagram illustrating an example processor core in accordance with an embodiment.

The figures of the drawings are not necessarily drawn to scale, as their dimensions can be varied considerably without departing from the scope of the present disclosure.

### DETAILED DESCRIPTION OF EXAMPLE EMBODIMENTS

### Example Embodiments

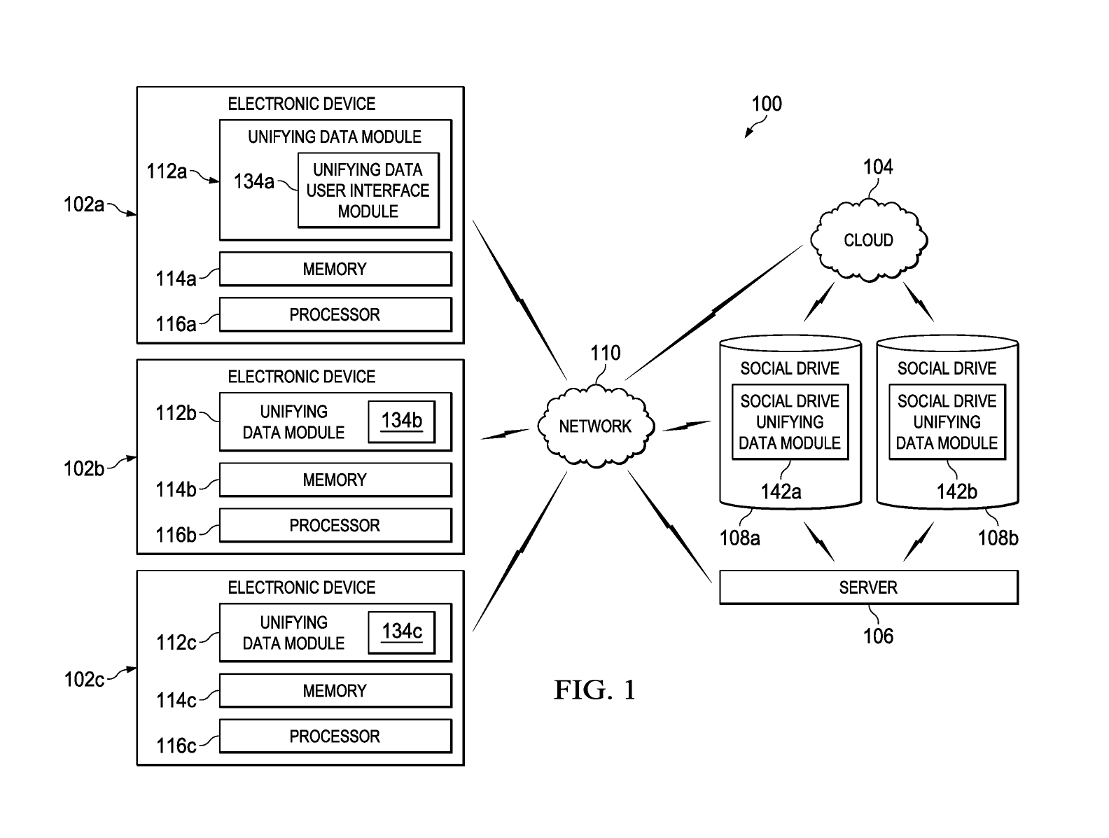

FIG. 1 is a simplified block diagram of a communication system 100 for sharing data using a social drive in accordance with an embodiment of the present disclosure. Communication system 100 can include electronic devices 102a, 102b, and 102c, a cloud 104, a server 106, and social drives 108a and 108b. Electronic device 102a can include a unifying data module 112a, memory 114a, and a processor 116a. Unifying data module 112a can include a unifying data user interface module 134a. Electronic device 102b can include a unifying data module 112b, memory 114b, and a processor 116b. Unifying data module 112b can include a unifying data user interface module 134b. Electronic device 102c can include a unifying data module 112c, memory 114c, and a processor 116c. Unifying data module 112c can include a unifying data user interface module 134c. Social drives 108a and 108b can each include a social drive unifying module 142a and 142b respectively. Electronic devices 102a, 102b, and 102c, cloud 104, server 106, and social drives 108a and 108b can communication with each other using network 110.

In example embodiments, communication system 100 can be configured to include a social drive for sharing data in the context of multiple of services and devices used by a group (e.g., a family, group of friends, etc.). The system can include a unified view, search, and access to personal data on a cloud and service content from any device. Data and metadata for the data can be separately managed so that the data can be stored on a device while the metadata is managed in multiple ways. Access to shared data can be abstracted so that the system allows access to multiple data sources owned by multiple members of a social drive (e.g., social drive 108a or 108b), without revealing the identity, authentication, or the location of the data. Mapping of data to owners of the data can be managed to the users with whom the data is shared. In an embodiment, the data may be rendered so that the original data is storable in the device where the shared data originated. In another embodiment, frequently accessed data may be cached. Using a cloud service or server, the social drive can abstract the location and access information so that any permitted members of a group can seamlessly access any of the data shared on the social drive.

In a specific example, the social drive can be configured to provide data location agnostic brokering services to members of the group. The addition of data to be shared to a chosen social drive can be done from a unified view without USB cables, login to services, or transfer of content. In an embodiment, the addition of data to be shared can be done by a single click from the owner of the data. The social drives do not host the data but maintain metadata regarding the data such as location, access, ownership information for the data, etc. The metadata allows for an agnostic search (e.g., interoperable among various systems) and access to the data. A user can invite group members from social circles to search, view, and contribute to a social drive using a single click. The social drive can also be configured to provide security and privacy of the data by brokering so that locations and credentials to access the data are hidden from the viewer of the shared data. The social drive can also help an owner retain control and of ownership of the data by controlling location, authorization to access to the data, as well as auditing access to the data The owner of the data can also withdraw viewing rights to the data.

The social drive can be configured to broker and provide an abstraction above physical devices and services (such as Facebook®, Google Drive®, etc.). The social drive can also be configured to provide an abstraction above location and ownership of the data. That is, the data stays where it originated and a data transfer does not occur until the data is needed by a specific group member who is allowed access. In an example, the social drive might optionally cache frequently accessed data during transfers. A single social drive may have multiple members, with each member having full control over only theft data. The access to each member's data is secure in that only specified members or users can access the data. The knowledge about the original location of the data or the credentials needed to access data are known only to the owners of the data and hidden from users who are permitted by the owners to access the data.

The system can be configured to leverage the idea that the data and the metadata identifying the data can managed separately. Sharing of files associated with a social drive provides transfer of files identified by the metadata and a user can share files (or access to files) without a task context. Also, the social drive can provide a common functionality with task-streaming, which is the ability to ensure that each device having access to the social drive has an up-to-date and searchable view of the metadata identifying files associated with the social drive.

Elements of FIG. 1 may be coupled to one another through one or more interfaces employing any suitable connections (wired or wireless), which provide viable pathways for network (e.g., network 110) communications. Additionally, any one or more of these elements of FIG. 1 may be combined or removed from the architecture based on particular configuration needs. Communication system 100 may include a configuration capable of transmission control protocol/Internet protocol (TCP/IP) communications for the transmission or reception of packets in a network. Communication system 100 may also operate in conjunction with a user datagram protocol/IP (UDP/IP) or any other suitable protocol where appropriate and based on particular needs.

For purposes of illustrating certain example techniques of communication system 100, it is important to understand the communications that may be traversing the network environment. The following foundational information may be viewed as a basis from which the present disclosure may be properly explained.

In many current systems, social sharing of data or content (photos, documents, videos, sounds, etc.) has continued to grow with the popularity of many forms of social networks (Facebook®, Google+®, Whatsapp®, LINE, etc.). Users typically share their content by uploading the content to a social networking site, content sharing site, email, or social messaging service.

In addition, there is a rapidly increasing number of cloud based services used by an individual user (e.g., Facebook®, Dropbox®, iCloud®, Google Drive®, etc.). Often, the number of cloud based services used by an individual user can be over five cloud based services. Further, there is a rapidly increasing number of devices used by a user and the devices can included various form factors such as smartphones, tablets, convertible or hybrid computers, wearable computers, laptops, desktops, etc. It is estimated that the number of devices used by a single user may be over five devices per user in the near future. Often a user will want to switch between devices and expect access to the same content on each device. However, typically the data is fragmented across devices and services and current models of sharing the data can become restrictive and cumbersome.

For example, in order to share data, a user needs to know the location of the data in a local device or service such as cloud service. Often, this requires the user to aggregate the content from the multiplicity of devices and upload the aggregated content (either manually or through a sync service) to a target service (such email or a cloud). Aggregation from devices usually requires USB cables or forces the user to automatically upload potentially unnecessary content with a sync service. Content from services (such as a photo sharing site) only provides a link that cannot be aggregated with device content. Also, once shared, the user loses control and ownership of the content in that the user has limited or no ability to control and audit the consumption of the shared content. In fact, most services modify the resolution of photos and videos and the user has no way to retrieve the original content. In addition, security can be a concern as the location of the content is revealed to the people with whom the user shares the content and the content can be further distributed without the knowledge or control of the user,

Further, typical sharing of content generated by a user (e.g., trip photos, project data, music collection, etc.) occurs via email, social networks, photo sharing sites, or cloud storage services. Social networking site and document sharing sites provide ways to create a group and provide group access, however, in order to share the data, the user typically must remember the location of the data and go to the location (e.g., local disk, cloud service, etc.) and access the data. This can become cumbersome with the increasing number of services and devices used by the users. The user must then upload to the sharing site either through service specific apps (as in sync services) or manual uploads. The sharing is easier if the data is already in a cloud-based service, but what is uploaded is a small portion of the overall data generated by the user. On most of the services, especially social networks, the user will lose control over the data the moment they share the data and it can be difficult to withdraw access to the data.

In addition, certain user tasks, including those around creativity and productivity usages can involve developing and improving user-generated content, including for example documents, photographs, research and analysis, and video, across multiple devices. Many of these tasks require multiple sessions with multiple devices, so that the tasks are started, progressed, and completed across multiple screens. Sometimes, such cross device usage is the result of a user's need to select the right device for the task at hand, for example by capabilities of the device, size of the screen, security features of the device, availability and capabilities of the applications, ease of use, or simply user's preference based on proximity or personal choice. Sometimes, such cross device usage is a result of users' need to collaborate on a task being done with a particular file where many users may need access to a particular file.

A communication system that includes a social drive for sharing data, as outlined in FIG. 1, can resolve these issues (and others). In communication system 100 of FIG. 1, the system can be configured to provide an abstraction where it is easy to use location agnostic sharing with security and privacy features where the user can continue to use their favorite device and services. For example, a social drive can be created using any one of electronic devices 102a, 102b, or 102c. When the social drive is created, the user can invite friends to join the social drive. The invited friends will get a notification of the social drive on any of the platforms that may be used by the friend (e.g., an app, social network, email, text message, etc.) The friends can accept to join the social drive and once accepted, the friends are now a member of the social drive. All of the changes to the social drive by other members of the social drive are reflected in a notification to the other members. Any member who has access to the social drive can access any file on the social drive. In addition, any member who has access to the social drive, can add their own data or files.

Information on the social drive can show who added the data to the social drive, but not the source of the data. Ownership to the data is respected in that a member can only delete the data they have added to the social drive. The access is brokered in that a member accessing shared data will never know the source and credentials needed to access the data from the data owners' account. The data is transferred either peer to peer when members are on the same network or through a cloud service. In one example, the accessed data may be cached locally so that the data can be accessed later when the source of the data is offline or the owner of the data is not connected to the internet.

The social drive can be hardened in multiple ways. For example, biometric-based authentication for the social drive may be used in order to make the access more secure. Platform-based counters and logging mechanism may also be used so that the system can monitor which members accessed what data and what they did with the data. The system can include a platform-based mechanism to control actions on the social drive data accessed on an endpoint. For example, the system may use extensions to control file access at a disk controller level and provide a platform-based ability to control member actions on the data such as read only. The management of metadata separate from the data itself enables the social drives to be shared among members. By providing the social drives, access to data can be shared seamlessly between users of different devices with minimal disruption and effort.

Metadata for identifying one or more files or data can include a file name, file identifier, file location, file size, file type, ownership information, permissions (or other suitable policies), security information such as scan results, preview icon, last edited time and date, time and date created, and any other suitable properties or characteristics associated with a file or data. Metadata does not include the full content of the file or data. Furthermore, metadata identifies the file or data in such a way which enables a device to retrieve the file or data from a storage device on which the file or data is stored (e.g., metadata may include an identifier for identifying the storage device and an identifier for identifying the location of the file or data on the storage device).

While the social drive can be configured to provide the basic function of sharing access to files or data among members, it is possible to extend this function to sharing task-contexts as well for performing operations on those files or data whose access is shared among the members. The system can be configured to allow task-contexts to be shared from one device to another device. A task-context can specify one or more files and one or more operations to be performed on the one or more files. By providing a task-context from one device to the other device, a user can accomplish a task with a particular file and seamlessly transition between devices with minimal disruption and effort. A “task-context” relates to a piece of work undertaken by a member, for example, an operation on a file or data using one or more capabilities of a member's device, where this task-context may exist across a plurality of devices. A task-context may be associated with a particular goal, or a step towards a goal, that the member or members may want to achieve with the file or data, irrespective of the application to be used or the location in which the goal is achieved.

The term “task” is meant to encompass the broad context of what a member is trying to accomplish with the data (an operation, a task, for example, editing a movie, editing a file, uploading to a website) and not executing a specific application. The streaming of task-contexts can be achieved through a framework for sharing data and related tasks across devices, so that a member or group of members can complete an activity, task, an operation, etc. across a set of devices.

To illustrate the concept of a “task-context”, generally speaking, an electronic device (e.g., electronic device 102a, 102b, or 102c) may have a set of one or more user preferences associated with capabilities corresponding to that device. A task-context may exist across each electronic device 102a, ion, and 102c and different capabilities may be used at each different electronic device for the task-context shared among electronic device 102a, 102b, and 102c. For example, a task context may relate to reading (operation) a Word document. Electronic device 102a may be a smartphone and have a Word doc previewer application or capability for reading the Word document. Electronic device 102b may be a tablet and have a light-weight Word application or capability for reading the Word document. Electronic device 102c may be a laptop and have a heavy-weight Word application or capability for reading, reviewing and editing the Word document All of these capabilities may differ from device to device, but the task-context of reading the Word document (i.e., the task/operation on the file) remains the same and is shared across the devices.

In some embodiments, these capabilities may be associated with user preferences for specific applications or capabilities for manipulating data or different types of files. A user may prefer to use a particular application on a particular user device to perform a specific operation. In some cases, a user may prefer to use a particular application over some other applications to perform a specific operation, even though those other applications are available on the same user device. Some user preferences may be deduced or inferred from user activity or configuration of the device or both. In some cases, some user preferences may be manually provided by the user or an administrator. For a particular file, it is possible that different capabilities may be used by different devices for performing the same operation, depending on the user preferences associated with the specific device.

In another example, a user takes a picture with electronic device 102a (e.g., a smartphone or camera in this example). The photo editor on electronic device 102a may be fairly basic, and the user may be more accustomed to editing applications on electronic device 102b (e.g., a desktop or laptop computer in this example). The user can create a task-context to push the task of editing the photo to electronic device 102b to edit the picture.

In yet another example, electronic device 102a (e.g., the family laptop in this example) has the complete music library for a family. A first user (e.g., a parent) wants to have another user's (e.g., a child's) favorites music on electronic device 102b (e.g., a tablet in this example) for a road trip. The first user can search and select the desired music on electronic device 102a and push the music to electronic device 102b. Alternatively or additionally, the first user can search, select, and push the needed songs to electronic device 102c, which may be a smart phone or a vehicle's entertainment system.

In a further example, a user may have downloaded some files from the Internet onto electronic device 102a (e.g., a tablet in this example). However, the user does not trust the safety of these files, so the user pushes the files to electronic device 102b (e.g., a desktop or laptop computer in this example with strong malware detection capabilities). Using electronic device 102b, the files can be scanned for malware.

In yet a further example, a first user (e.g., a student or employee) is working on a project on electronic device 102a (e.g., a desktop or laptop computer in this example) and wants a second user (e.g., a teacher, co-worker, or manager) to review the project on electronic device 102b (e.g., a tablet in this example). The first user can pushes the file, directly from the context of working on the file from electronic device 102a to electronic device 102b, possibly with a text annotation asking the second user to look at a certain aspect of the project. The second user can receive a notification on electronic device 102b regarding the request and can work on the document when the second user has time. It is important to note that, when the second user has time to work on the project, the second user has everything they need including the context and the data so that productivity may be enhanced. Note further that, the second user in turn can return the corrected project from electronic device 102b to the first user on electronic device 102a using another task-context.

In another example, a user shoots a video using electronic device 102a (e.g., a smart phone in this example), and wants to view the video on electronic device 102b (e.g., a tablet in this example), which has a larger screen. The user can push the video file from electronic device 102a (optionally converted to a different format more suitable for the tablet) as a task-context to electronic device 102b. The conversion can occur transparently to the user, in that the user selects the task to view the video, but does not realize that the video file is converted to a different format more suitable for the tablet.

The above use cases of task streaming across multiple devices (e.g., electronic device 102a, electronic device 102b, and electronic device 102c) are accompanied by the ability to search, display, and convert content across devices, the ability to manage metadata and content transfers, and a notification system. Note that according to one or more above examples, users may avoid inefficient and round-about methods of exchanging information such as exchanging e-mail with attachments or using cables to connect devices together. The ability of task-contexts and sharing of task-contexts across devices adds a purpose or intent to the data sharing action, especially in creative and productive activities and the user does not need access to a cloud service to share data within a local network.

Turning to the infrastructure of FIG. 1, communication system 100 in accordance with an example embodiment is shown. Generally, communication system 100 can be implemented in any type or topology of networks. Network 110 represents a series of points or nodes of interconnected communication paths for receiving and transmitting packets of information that propagate through communication system 100. Network 110 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In communication system 100, network traffic, which is inclusive of packets, frames, signals, data etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in communication system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

In an example implementation, electronic devices 102a, 102b, and 102c, cloud 104, and server 106 are network elements, which are meant to encompass network appliances, servers, routers, switches, gateways, bridges, load balancers, processors, modules, or any other suitable device, component, element, or object operable to exchange information in a network environment. Network elements may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with communication system 100, each of electronic devices 102a, 102b, and 102c, cloud 104, and server 106 can include memory elements for storing information to be used in the operations outlined herein. Each of electronic devices 102a, 102b, and 102c, cloud 104, and server 106 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in communication system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of communication system 100, such as electronic devices 102a, 102b, and 102c, may include software modules (e.g., unifying data modules 112a, 112b, and 112c respectively) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of electronic devices 102a, 102b, and 102c, cloud 104, and server 106 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic devices 102a, 102b, and 102c can be a network element and includes, for example, desktop computers, laptop computers, mobile devices, personal digital assistants, smartphones, tablets, or other similar devices. Cloud 104 is configured to provide cloud services to electronic devices 102a, 102b, and 102c. Cloud services may generally be defined as the use of computing resources that are delivered as a service over a network, such as the Internet. Typically, compute, storage, and network resources are offered in a cloud infrastructure, effectively shifting the workload from a local network to the cloud network. Server 106 can be a network element such as a server or virtual server and can be associated with clients, customers, endpoints, or end users wishing to initiate a communication in communication system 100 via some network (e.g., network 110). The term ‘server’ is inclusive of devices used to serve the requests of clients and/or perform some computational task on behalf of clients within communication system 100. Although unifying data modules 112a, 112b, and 112c are represented in FIG. 1 as being located in electronic devices 102a, 102b, and 102c respectively, this is for illustrative purposes only. Unifying data modules 112a, 112b, and 112c could be combined or separated in any suitable configuration. Furthermore, unifying data modules 112a, 112b, and 112c could be integrated with or distributed in another network accessible by electronic devices 102a, 102b, and 102c respectively.

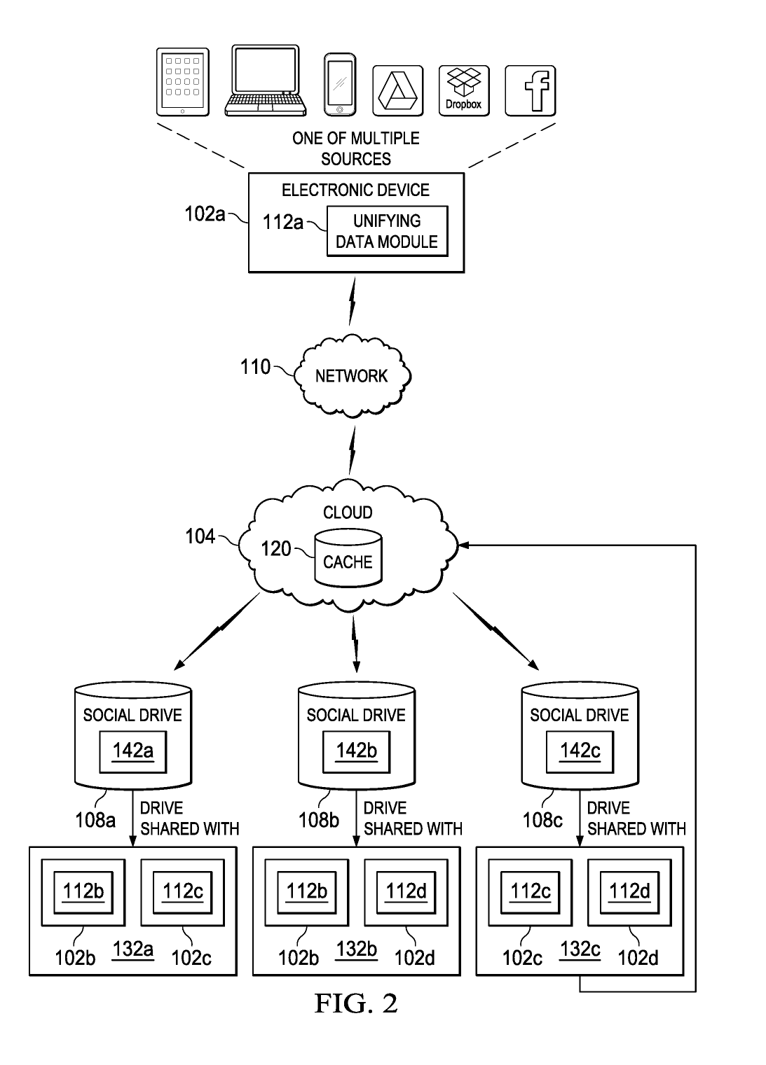

Turning to FIG. 2, FIG. 2 is a simplified block diagram of communication system 100 for sharing data in accordance with an embodiment of the present disclosure. Each social drive 108a, 108b, and 108c may be associated with a group of devices or users that has access to the respective social drive. For example, social drive 108a may be associated with a first group 132a that includes electronic devices 102b and 102c. Social drive 108b may be associated with a second group 132b that includes electronic device 102b and an electronic device 102d. Electronic device 102d can include unifying data module 112d. Social drive 108c may be associated with a third group 132c that can include electronic devices 102c and 102d. While FIG. 2 illustrates two electrical devices in each group, first group 132a, second group 132b, and third group 132c can each include one or more electronic devices and each be associated with one or more users. In addition, the electrical devices in each group may be associated with the same user or different users.

In an example, a user may use electronic device 102a to select data to be shared. As illustrated in FIG. 2, electronic device 102a represents one of a plurality of electronic devices associated with the user. For example, electronic device 102a can represent a tablet, a laptop, or a smartphone. In addition, electronic device 102a may have access to a cloud service such as Facebook®, Dropbox®, Google Drive®, or some other cloud service. Unifying data module 112a can push or otherwise communicate selected data to one or more of social drives 108a, 108b, and 108c where the data can be accessed by members of the group associated with the social drive (e.g., users of electronic devices 102b, 102c, or 102d). In a specific example, a user may select a photo that was taken with a smart phone and is located on electronic device 102a. Unifying data module 112a can communicate metadata regarding the photo to social drive 108b where the photo can be accessed by members (e.g., users of electronic devices 102b and 102d) of second group 132b. In one example, the actual photo file or photo data is stored on electronic device 102a. In another example, the actual photo file or photo data can be stored in a cache 120 located in cloud 104 (or in server 106, not shown). The metadata includes information about where the original photo file or photo data is stored.

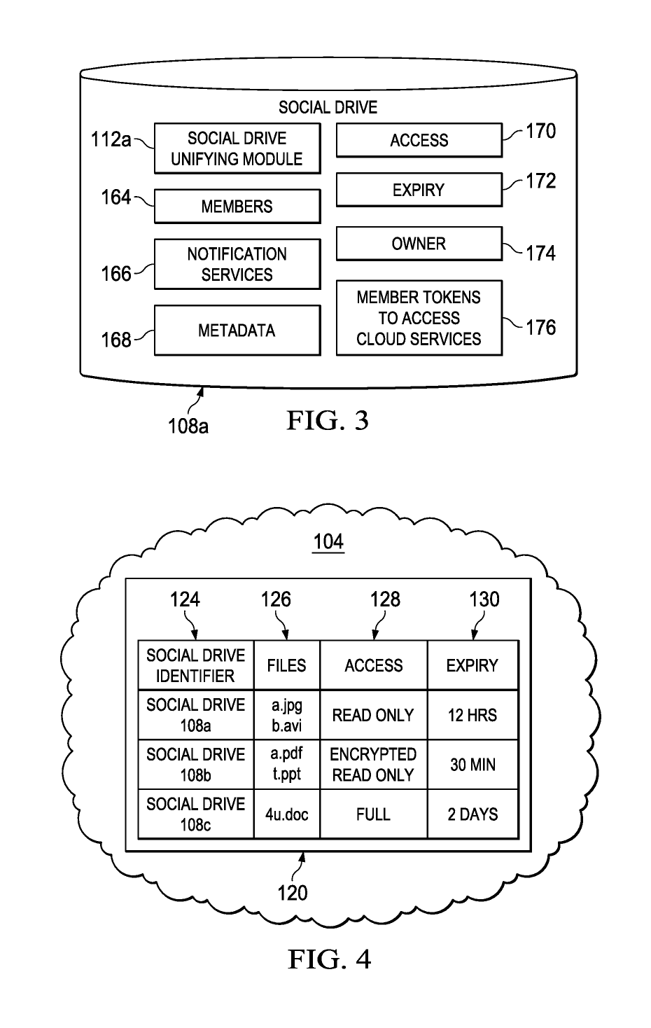

Turning to FIG. 3, FIG. 3 is a simplified block diagram of a portion of communication system 100. Social drive 108a (and 108b and 108c) can include social drive unifying module 142a, members 164, notification services 166, metadata 168, access information 170, expiry information 172, owner of data information 174, and member tokens to access cloud services 176. Members 164 can include a list of members that belong to social drive 108a. Each member can have multiple different electronic devices that may be used to access data shared using social drive 108a. Notification services 166 can include information related to how each member wants to be notified when content is shared or modified using social drive 108a. For example, a member may wish to be notified via text message, an email, phone call, or some other type of notification. Metadata 168 can include metadata related to each of the data that is shared using social drive 108a. Access information 170 can include information related to how the data can be accessed. For example, some data may be read only while other data may have no restrictions associated with access to the data. Expiry information 172 can include information related to when access to each of the shared data expires. For example, access to the data may expire after a certain numbers of minutes, hours, days, weeks, months, or any combination thereof. Owner of data information 174 includes information related to the owner of each of the data (e.g., the user that created the data or uploaded the data, or both). Member tokens to access cloud services 176 can include information related data that is stored on a cloud service. For example, if data is stared on an iCloud®, then to access the data, the authorization to enter the cloud must be known and used before the cloud can be entered to retrieve the data.

Turning to FIG. 4, FIG. 4 is a simplified block diagram of a portion of communication system 100. Cache 120 can include a file or files 126, a social drive identifier 124, access 128, and expiry 130. File or files 126 can be files or data that have been shared by a user and are stored in cache 120. Social drive identifier 124 can include information that identifies the group with which the data is shared. Access 128 can include information related to how the data can be accessed. For example, some data may be read only, some may be encrypted and read only, while other data may have no restrictions associated with access to the data. Expiry 130 can include information related to when access to the data expires. For example, the data or files may have an expiry of twelve (12) hours, thirty (30) minutes, two (2) days, etc.

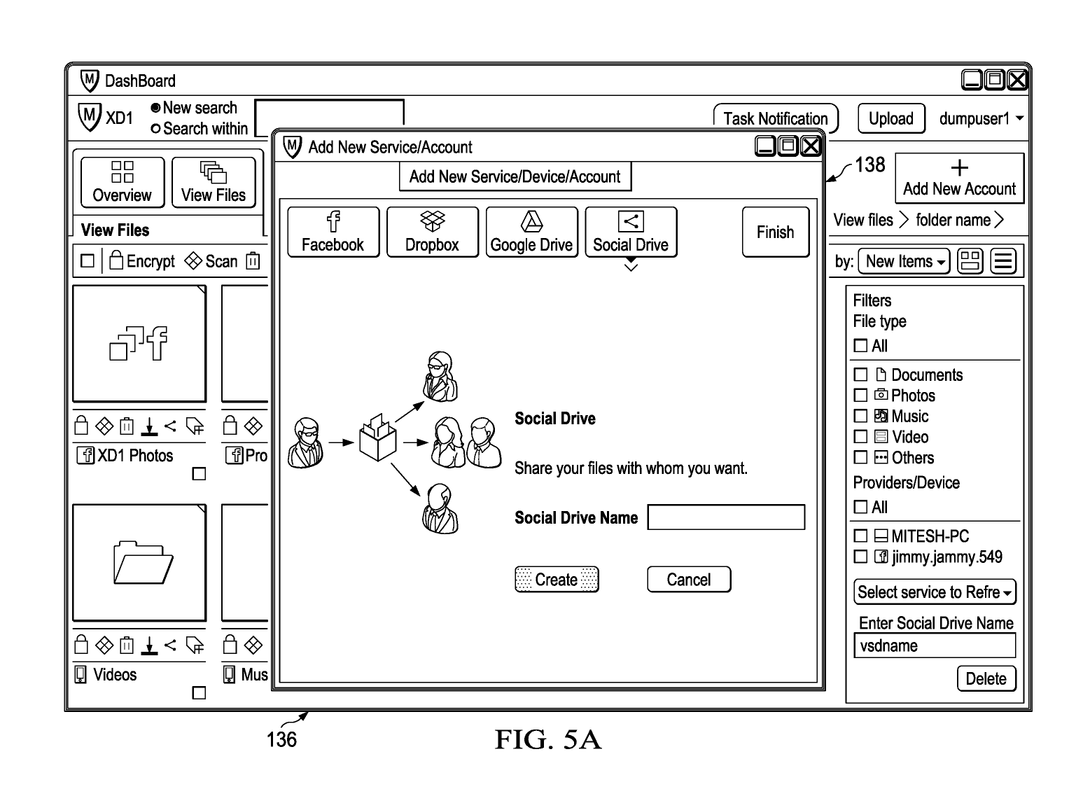

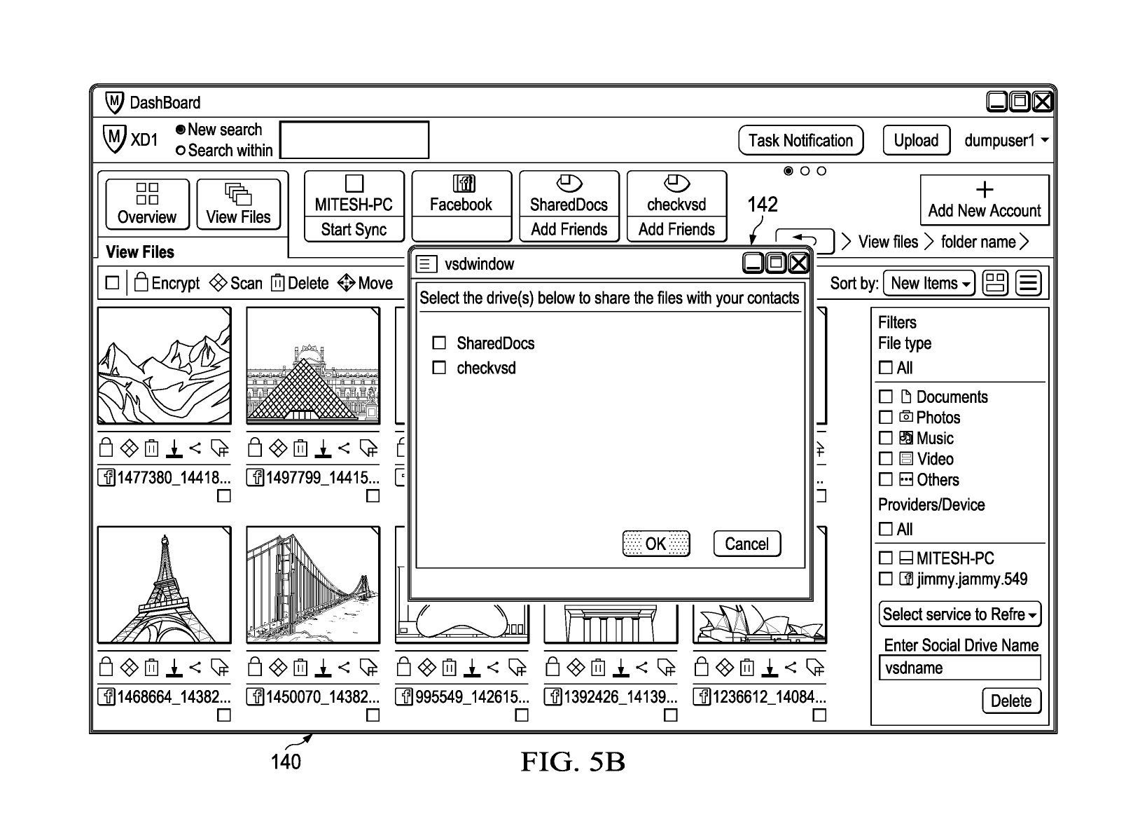

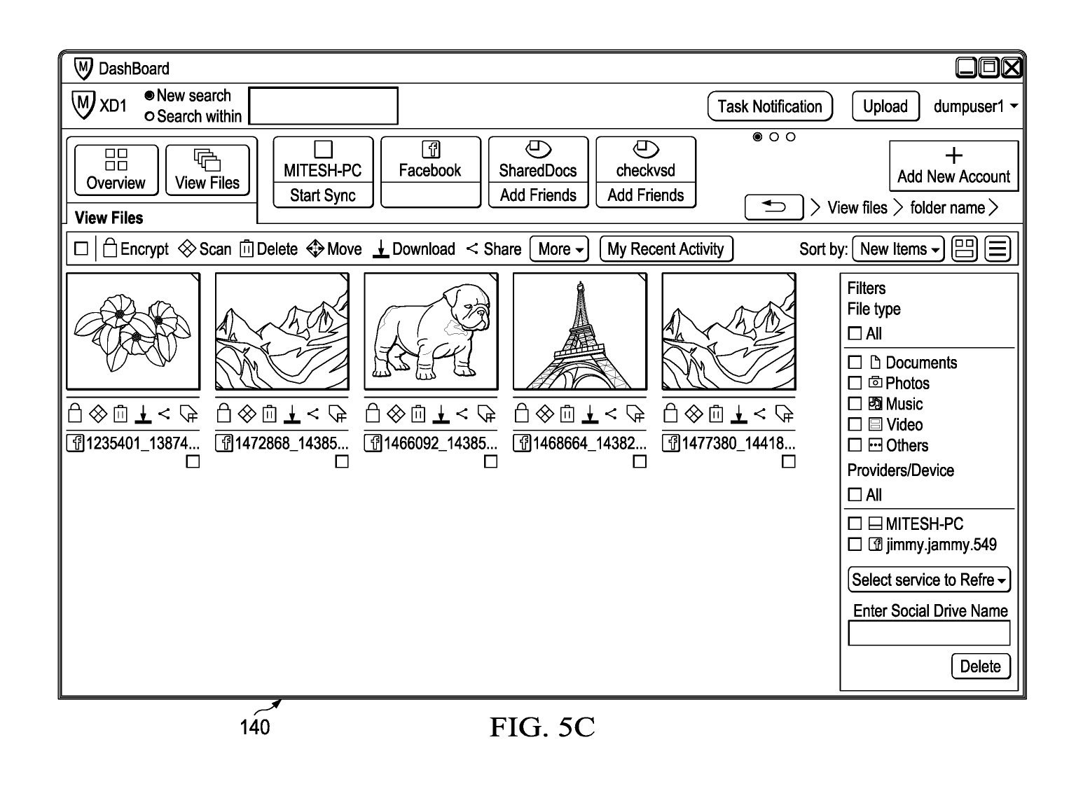

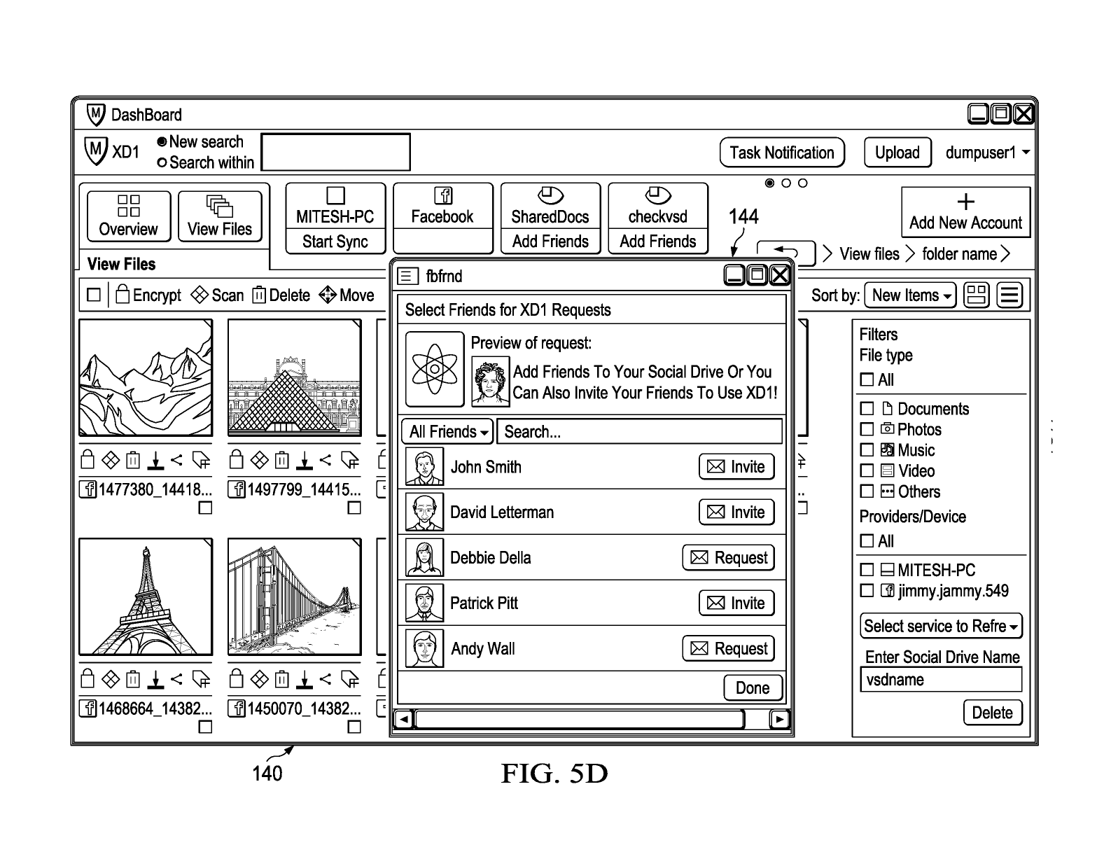

Turning to FIG. 5A, FIG. 5A is a simplified block diagram of a portion of communication system 100. Unifying data user interface module 134 can be configured to create a new service user interface (UI) 136. New service UI 136 can be used to create a new social drive. For example, new service UI 136 could be used to create social drive 108a. New service UI 136 can include an add a new service/account UI 138. Using new service/account UI 138, a user can create and name a new social drive.

Turning to FIG. 5B, FIG. 5B is a simplified block diagram of a portion of communication system 100. Unifying data user interface module 134 can be configured to create a share data UI 140. Share data UI 140 allows a user to select a drive where data that a user wants to share on a social drive is located. For example, a user may select a drive located on electronic device 102a (e.g., SharedDocs) or a cloud account (e.g., checkvsd) that includes data a user wants to share. Turning to FIG. 5C, FIG. 5C is a simplified block diagram of a portion of communication system 100. Once a drive is selected, share data UI 140 can be configured to allow a user to select the data an the drive that a user wants to share.

Turning to FIG. 5D, FIG. 5D is a simplified block diagram of a portion of communication system 100. Once data to be shared is selected, share data UI 140 can be configured to allow a user to select the other users that will have access to the data. Also, when a social drive is first being created, the user can use a UI similar to shard data UI 140 to select friends or other users to be members of the created social drive. If a social drive has already been created, then share data UI 140 may present a list of contacts that the user can select to add to the social drive.

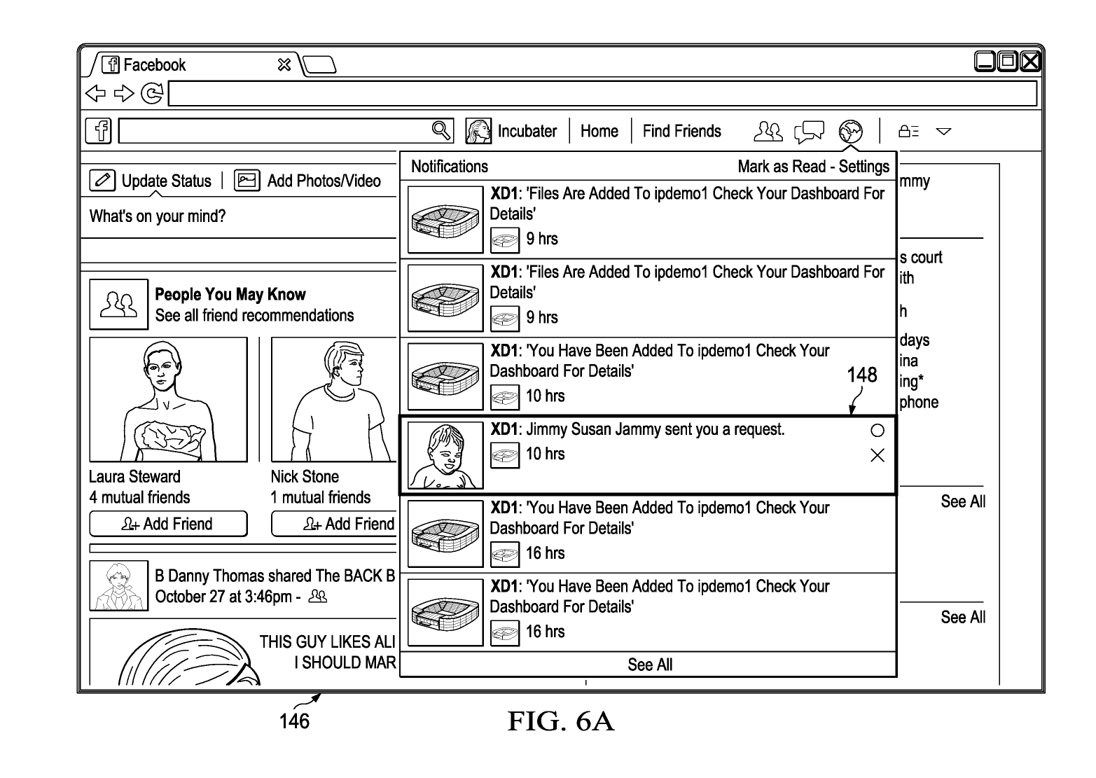

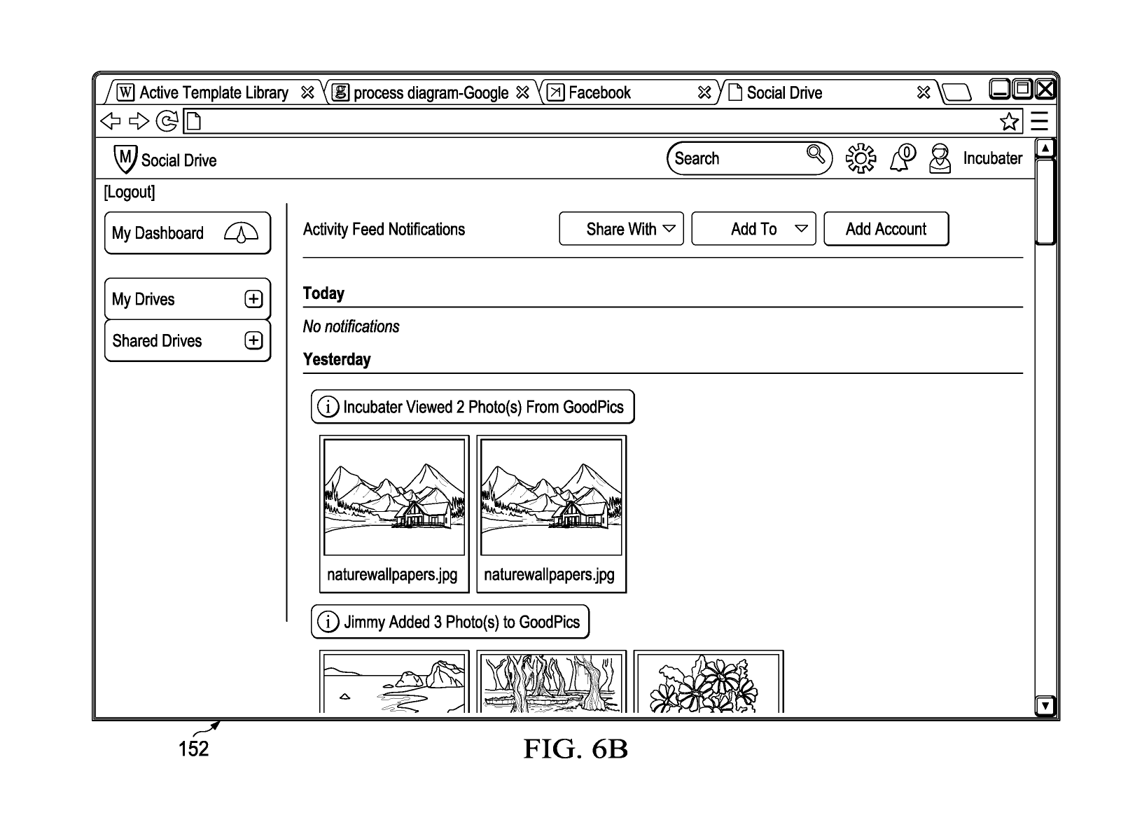

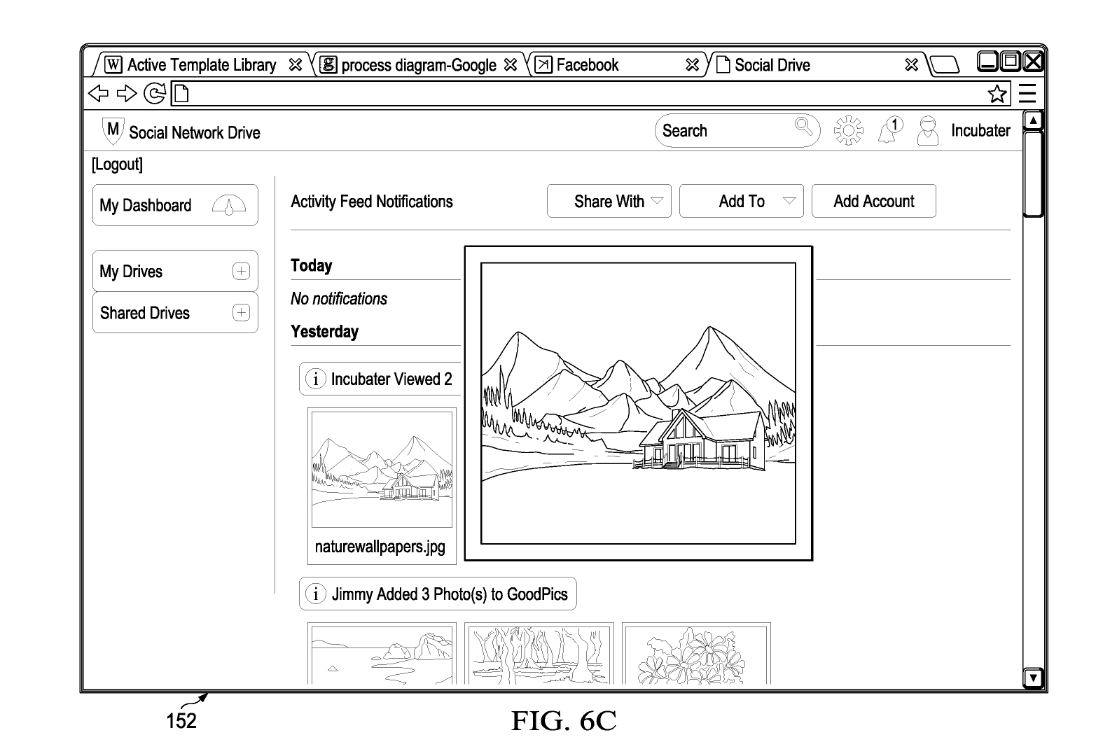

Turning to FIG. 6A, FIG. 6A is a simplified block diagram of a portion of communication system 100. Unifying data user interface module 134 can be configured to create a notification UI 146. Notification UI 146 can be configured to present or display notifications to a user. For example, when a user is sent a request to join a social drive, a notification similar to request to join notification 148 may be presented to the user in notification UI 146.

Turning to FIG. 6B, FIG. 6B is a simplified block diagram of a portion of communication system 100. Unifying data user interface module 134 can be configured to create a home page UI 152. Home page UI 152 can be configured to display information about a social drive that the user is a member. For example, FIG. 6B illustrated that another user (Jimmy) added two pictures and two photos to the social drive. Turning to FIG. 6C, FIG. 6C is a simplified block diagram of a portion of communication system 100. Using home page UI 152, a user can select any of the data in the shared drive and view the data.

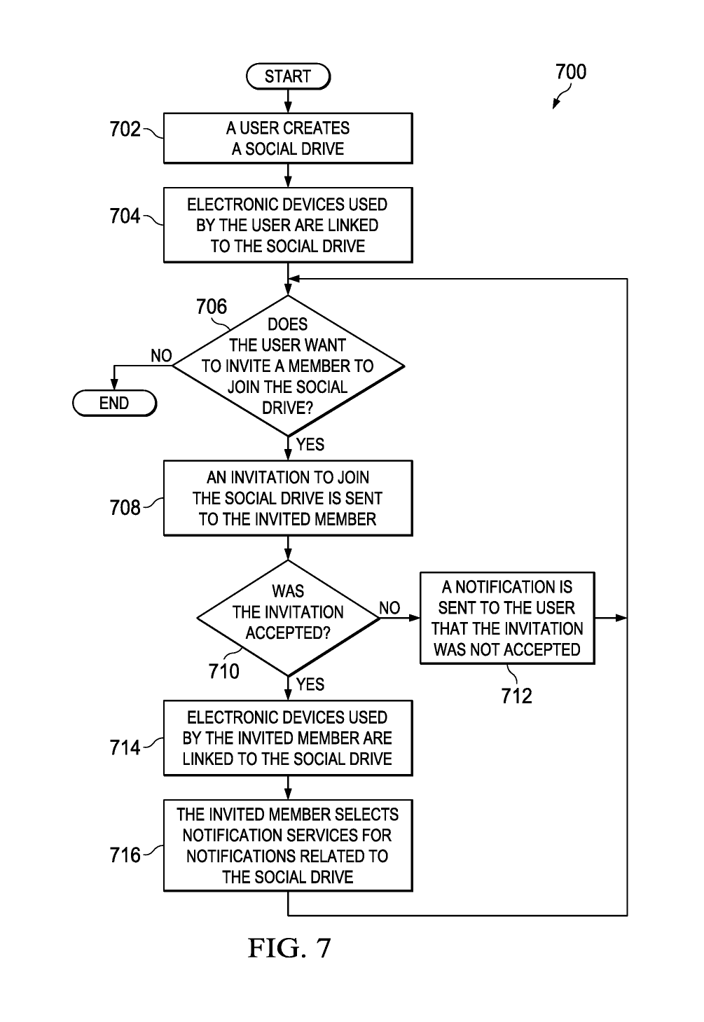

Turning to FIG. 7, FIG. 7 is an example flowchart illustrating possible operations of a flow 700 that may be associated with sharing data using a social drive, in accordance with an embodiment. In an embodiment, one or more operations of flow 700 may be performed by unifying data module 112a, 112b, and 112c and social drive unifying module 142a, 142b, and 142c. At 702, a use creates a social drive. At 704, electronic devices used by the user are linked to the social drive. At 706, the system determines if the user wants to invite a member to join the social drive. If the user wants to invite a member to join the social drive, then an invitation to join the social drive is sent to the invited member, as in 708. At 710, the system determines if the invitation was accepted. If the invitation was not accepted, then a notification is sent to the user that the invitation was not accepted, as in 712. If the invitation was accepted, then electronic devices used by the invited member are linked to the social drive, as in 714. At 716, the invited member selects notification services for notifications related to the social drive.

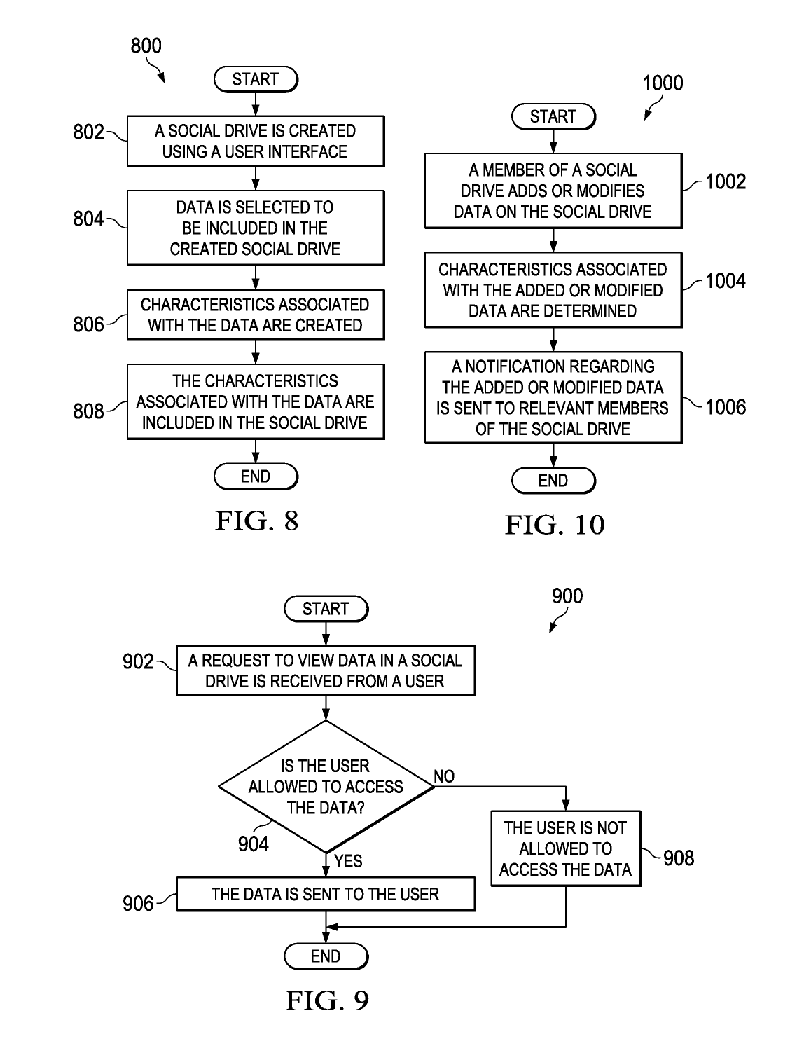

Turning to FIG. 8, FIG. 8 is an example flowchart illustrating possible operations of a flow 800 that may be associated with sharing data using a social drive, in accordance with an embodiment. In an embodiment, one or more operations of flow 800 may be performed by unifying data module 112a, 112b, and 112c and social drive unifying module 142a, 142b, and 142c. At 802, a social drive is created using a user interface. At 804, data is selected to be included in the created social drive. At 806, characteristics associated with the data are created. The characteristics can include metadata relating to the data, where the metadata identifies the location of the shared data. The characteristics can also include ownership information of the data, allowed access to the data, expiry information for the data, etc. At 808, the characteristics associated with the data are included in the social drive.

Turning to FIG. 9, FIG. 9 is an example flowchart illustrating possible operations of a flow 900 that may be associated with sharing data using a social drive, in accordance with an embodiment. In an embodiment, one or more operations of flow 900 may be performed by unifying data module 112a, 112b, and 112c and social drive unifying module 142a, 142b, and 142c. At 902, a request to view data in a social drive is received from a user. At 904, the system determines if the user is allowed to access the data. For example, the system can determine if the user is a member of the social drive that includes the data (or metadata that references the data), if the data is still available, if access to the data has expired, etc. If the system determines that the user is not allowed to access the data, then the user is not allowed to access the data, as in 908. If the system determines that the user is allowed to access the data, then the data is sent to the user, as in 906.

Turning to FIG. 10, FIG. 10 is an example flowchart illustrating possible operations of a flow 1000 that may be associated with sharing data using a social drive, in accordance with an embodiment. In an embodiment, one or more operations of flow 1000 may be performed by unifying data module 112a, 112b, and 112c and social drive unifying module 142a, 142b, and 142c. At 1002, a member of a social drive adds or modifies data on a social drive. At 1004, characteristics associated with the added or modified data are determined. At 1006, a notification regarding the added or modified data is sent to relevant members of the social drive.

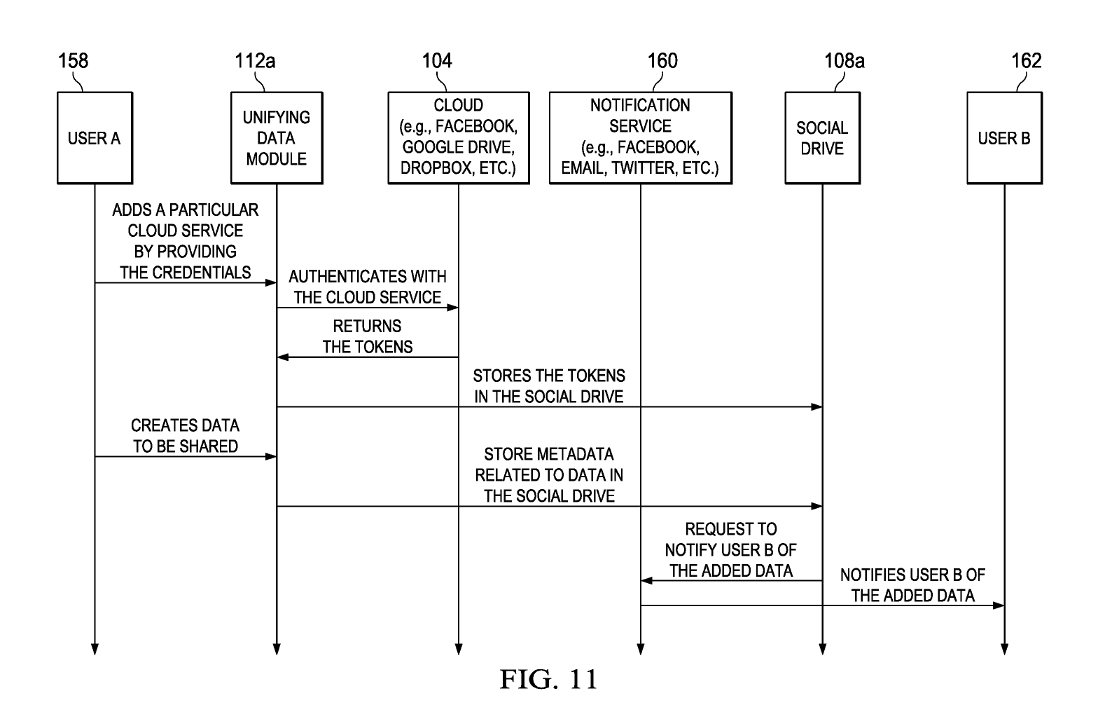

Turning to FIG. 11, FIG. 11 is a simplified timing diagram illustrating one possible set of details associated with communication system 100. This particular configuration includes a user A 158, unifying data module 112a, cloud 104, a notification service 160, social drive 108a, and a user B 162. In operational terms, user A 158 adds a particular cloud service by providing credentials to access the cloud services. For example, user A 158 may add a cloud service of photo sharing by adding the credentials to access an account of user A 158 on Shutterfly®. Unifying data module 112a can be configured to authenticate with the cloud services and in response, cloud 104 can return authentication tokens to unifying data module 112a. The authentication tokens can allow access to the services of the cloud related to the user. Unifying data module 112a can send the tokens to social drive 108a for storage (e.g., the tokens may be stored in member tokens to access cloud services 176). In addition, user A 258 can create data or selected data in the cloud service that user A 258 wants to share with other users (e.g., user B 162). Unifying data module 112a can store metadata related to the data in social drive 108a. The metadata can identify the location of the data user A 258 wants to share. Social drive 108a can request that a notification is sent regarding the shared data. In response, notification service 160 can notify user B 162 of the added data.

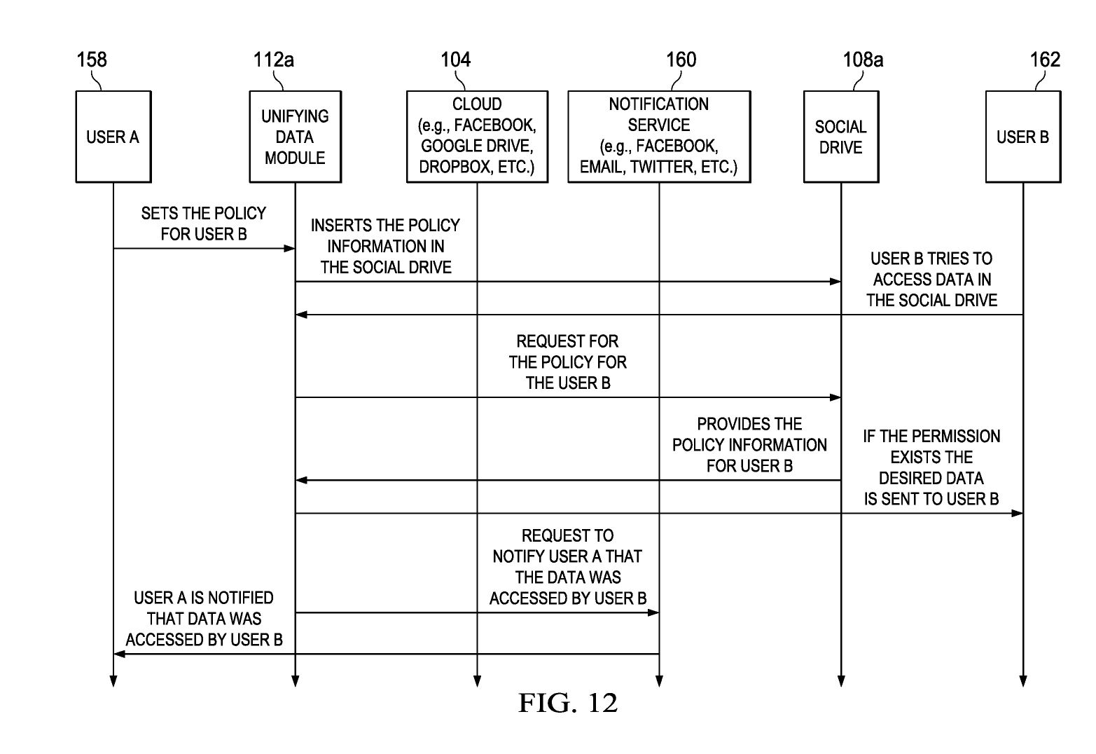

Turning to FIG. 12, FIG. 12 is a simplified timing diagram illustrating one possible set of details associated with communication system 100. This particular configuration includes user A 158, unifying data module 112a, cloud 104, notification service 160, social drive 108a, and user B 162. In operational terms, user A 158 can set a policy for user B 162. Unifying data module 112a can insert the policy information on social drive 108a. When user B 162 tries to access data in social drive 108a the metadata for the data in social drive 108a is accessed and the metadata can identify the location of the data, in this case, being the same location as the location of unifying data module 112a instead of a cloud service or some other location. In response to the request for the data, unifying data module 112a can send a request for the policy for user B to social drive 108a. The policy for user B is located at social drive 108a because that is a central location and can be accessed by many different devices associated with user A 158. Social drive 108a can provide the policy information for user B to unifying data module 112a. If the permission exists to access the data, then the desired data is send to user B 162. When the desired data is sent to user B 162, unifying data module also sends a request to notification service 160 to notify user A 158 that the data was accessed by user B 162. Notification service 160 can notify user A 158 that the data was accessed by user B 162. By notifying user A 158 that data was accessed by user B 162, user A 158 can monitor the access to the data.

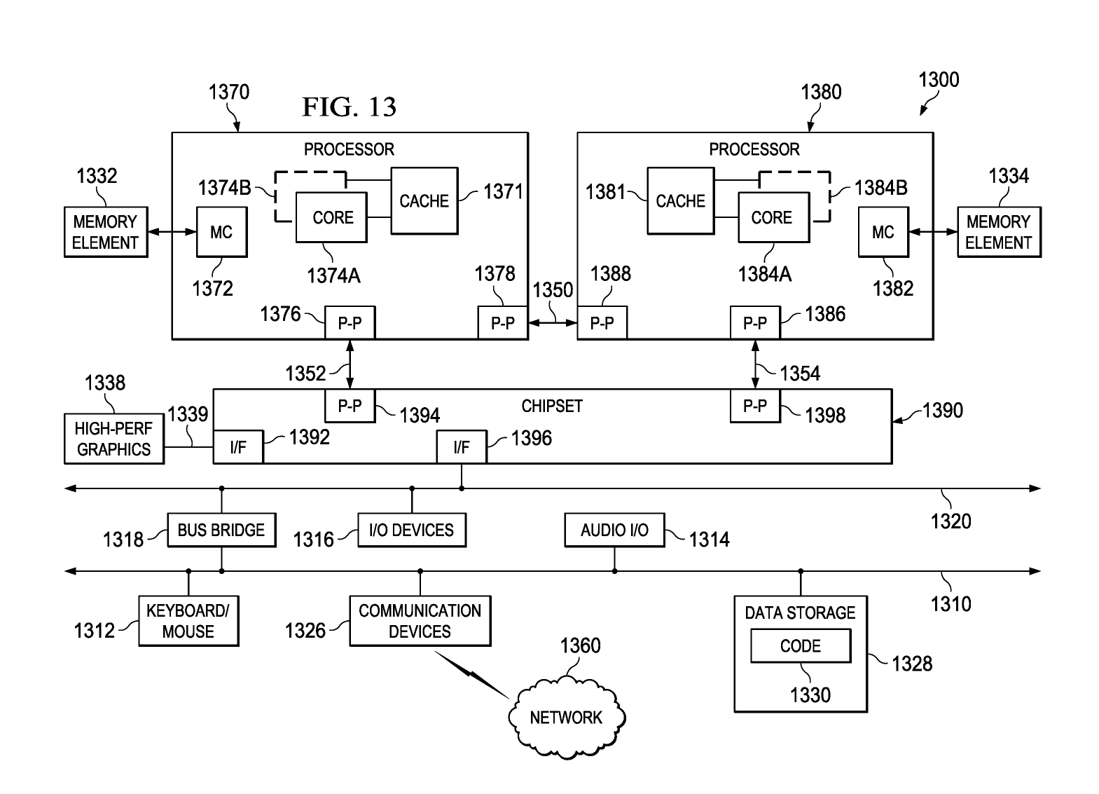

FIG. 13 illustrates a computing system 1300 that is arranged in a point-to-point (PtP) configuration according to an embodiment. In particular, FIG. 13 shows a system where processors, memory, and input/output devices are interconnected by a number of point-to-point interfaces. Generally, one or more of the network elements of communication system 100 may be configured in the same or similar manner as computing system 1300.

As illustrated in FIG. 13, system 1300 may include several processors, of which only two, processors 1370 and 1380, are shown for clarity. While two processors 1370 and 1380 are shown, it is to be understood that an embodiment of system 1300 may also include only one such processor. Processors 1370 and 1380 may each include a set of cores (i.e., processor cores 1374A and 1374B and processor cores 1384A and 1384B) to execute multiple threads of a program. The cores may be configured to execute instruction code in a manner similar to that discussed above with reference to FIGS. 1-12. Each processor 1370, 1380 may include at least one shared cache 1371, 1381. Shared caches 1371, 1381 may store data (e.g., instructions) that are utilized by one or more components of processors 1370, 1380, such as processor cores 1374 and 1384.

Processors 1370 and 1380 may also each include integrated memory controller logic (MC) 1372 and 1382 to communicate with memory elements 1332 and 1334. Memory elements 1332 and/or 1334 may store various data used by processors 1370 and 1380. In alternative embodiments, memory controller logic 1372 and 1382 may be discrete logic separate from processors 1370 and 1380.

Processors 1370 and 1380 may be any type of processor and may exchange data via a point-to-point (PtP) interface 1350 using point-to-point interface circuits 1378 and 1388, respectively. Processors 1370 and 1380 may each exchange data with a chipset 1390 via individual point-to-point interfaces 1352 and 1354 using point-to-point interface circuits 1376, 1386, 1394, and 1398. Chipset 1390 may also exchange data with a high-performance graphics circuit 1338 via a high-performance graphics interface 1339, using an interface circuit 1392, which could be a PtP interface circuit. In alternative embodiments, any or all of the PtP links illustrated in FIG. 13 could be implemented as a multi-drop bus rather than a PtP link.

Chipset 1390 may be in communication with a bus 1320 via an interface circuit 1396. Bus 1320 may have one or more devices that communicate over it, such as a bus bridge 1318 and I/O devices 1316. Via a bus 1310, bus bridge 1318 may be in communication with other devices such as a keyboard/mouse 1312 (or other input devices such as a touch screen, trackball, etc.), communication devices 1326 (such as modems, network interface devices, or other types of communication devices that may communicate through a computer network 1360), audio I/O devices 1314, and/or a data storage device 1328. Data storage device 1328 may store code 1330, which may be executed by processors 1370 and/or 1380. In alternative embodiments, any portions of the bus architectures could be implemented with one or more PtP links.

The computer system depicted in FIG. 13 is a schematic illustration of an embodiment of a computing system that may be utilized to implement various embodiments discussed herein. It will be appreciated that various components of the system depicted in FIG. 13 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

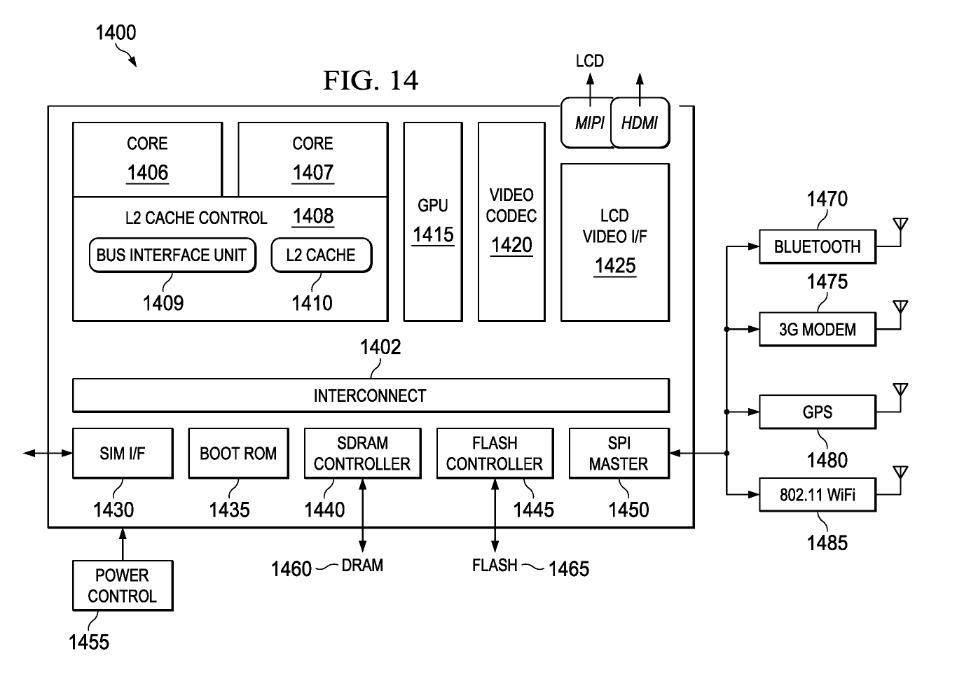

Turning to FIG. 14, FIG. 14 is a simplified block diagram associated with an example ARM ecosystem SOC 1400 of the present disclosure. At least one example implementation of the present disclosure can include the social drive features discussed herein and an ARM component. For example, the example of FIG. 14 can be associated with any ARM core (e.g., A-9, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 14, ARM ecosystem SOC 1400 may include multiple cores 1406-1407, an L2 cache control 1408, a bus interface unit 1409, an L2 cache 1410, a graphics processing unit (GPU) 1415, an interconnect 1402, a video codec 1420, and a liquid crystal display (LCD) I/F 1425, which may be associated with mobile industry processor interface (M WI)/high-definition multimedia interface (HDM I) links that couple to an LCD.

ARM ecosystem SOC 1400 may also include a subscriber identity module (SIM) I/F 1430, a boot read-only memory (ROM) 1435, a synchronous dynamic random access memory (SDRAM) controller 1440, a flash controller 1445, a serial peripheral interface (SPI) master 1450, a suitable power control 1455, a dynamic RAM (DRAM) 1460, and flash 1465. In addition, one or more example embodiments include one or more communication capabilities, interfaces, and features such as instances of Bluetooth™ 1470, a 3G modem 1475, a global positioning system (GPS) 1480, and an 802.11 Wi-Fi 1485.

In operation, the example of FIG. 14 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobes® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

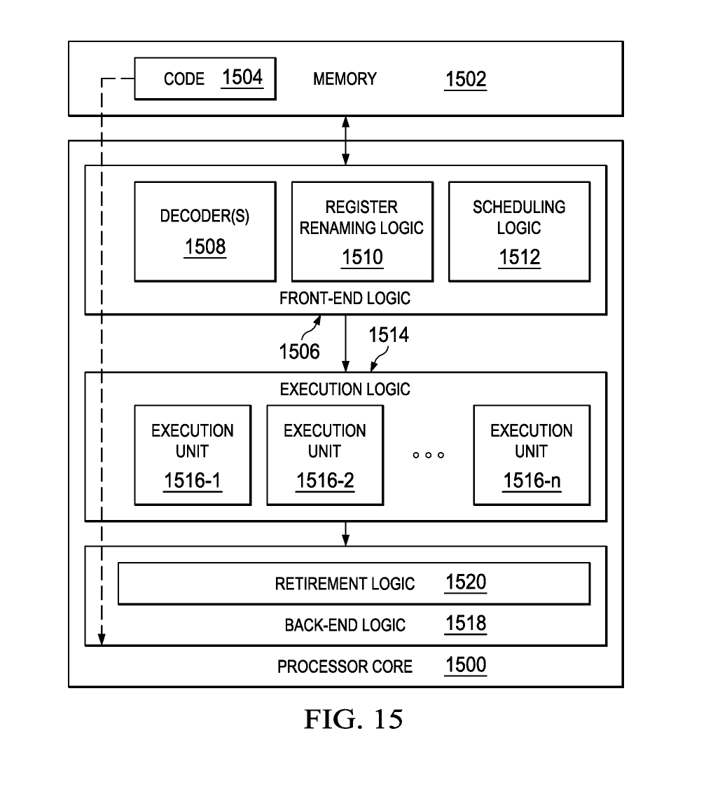

FIG. 15 illustrates a processor core 1500 according to an embodiment. Processor core 1500 may be the core for any type of processor, such as a micro-processor, an embedded processor, a digital signal processor (DSP), a network processor, or other device to execute code. Although only one processor core 1500 is illustrated in FIG. 15, a processor may alternatively include more than one of the processor core 1500 illustrated in FIG. 15. For example, processor core 1500 represents one example embodiment of processors cores 1374a, 1374b, 1374a, and 1374b shown and described with reference to processors 1370 and 1380 of FIG. 13. Processor core 1500 may be a single-threaded core or, for at least one embodiment, processor core 1500 may be multithreaded in that it may include more than one hardware thread context (or “logical processor”) per core.

FIG. 15 also illustrates a memory 1502 coupled to processor core 1500 in accordance with an embodiment. Memory 1502 may be any of a wide variety of memories (including various layers of memory hierarchy) as are known or otherwise available to those of skill in the art. Memory 1502 may include code 1504, which may be one or more instructions, to be executed by processor core 1500. Processor core 1500 can follow a program sequence of instructions indicated by code 1504. Each instruction enters a front-end logic 1506 and is processed by one or more decoders 1508. The decoder may generate, as its output, a micro operation such as a fixed width micro operation in a predefined format, or may generate other instructions, microinstructions, or control signals that reflect the original code instruction. Front-end logic 1506 also includes register renaming logic 1510 and scheduling logic 1512, which generally allocate resources and queue the operation corresponding to the instruction for execution.

Processor core 1500 can also include execution logic 1514 having a set of execution units 1516-1 through 1516-N. Some embodiments may include a number of execution units dedicated to specific functions or sets of functions. Other embodiments may include only one execution unit or one execution unit that can perform a particular function. Execution logic 1514 performs the operations specified by code instructions.

After completion of execution of the operations specified by the code instructions, back-end logic 1518 can retire the instructions of code 1504. In one embodiment, processor core 1500 allows out of order execution but requires in order retirement of instructions. Retirement logic 1520 may take a variety of known forms (e.g., re-order buffers or the like). In this manner, processor core 1500 is transformed during execution of code 1504, at least in terms of the output generated by the decoder, hardware registers and tables utilized by register renaming logic 1510, and any registers (not shown) modified by execution logic 1514.

Although not illustrated in FIG. 15, a processor may include other elements on a chip with processor core 1500, at least some of which were shown and described herein with reference to FIG. 13. For example, as shown in FIG. 13, a processor may include memory control logic along with processor core 1500. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that communication system 100 and and their teachings are readily scalable and can accommodate a large number of components, as well as more complicated/sophisticated arrangements and configurations. Accordingly, the examples provided should not limit the scope or inhibit the broad teachings of communication system 100 and as potentially applied to a myriad of other architectures.

It is also important to note that the operations in the preceding flow diagrams (i.e., FIGS. 7-10) illustrate only some of the possible correlating scenarios and patterns that may be executed by, or within, communication system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although communication system 100 have been illustrated with reference to particular elements and operations that facilitate the communication process, these elements and operations may be replaced by any suitable architecture, protocols, and/or processes that achieve the intended functionality of communication system 100.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable storage medium having one or more instructions that, when executed by at least one processor, cause the at least one processor to receive a request from a member of a social drive to view data, determine metadata for the data, where the metadata is located on the social drive, locate the data based on the determined metadata, where the data is not located on the social drive, and communicate the data to the member of the social drive.

In Example C2, the subject matter of Example C1 can optionally include where the data is located on an electronic device that communicated the metadata to the social drive.

In Example C3, the subject matter of any one of Examples C1-C2 can optionally include where the social drive includes a plurality of members and a notification was sent to each of the plurality of members when the metadata was communicated to the social drive.

In Example C4, the subject matter of any one of Examples C1-C3 can optionally include where the plurality of members do not have access to the location of the data.

In Example C5, the subject matter of any one of Example C1-C4 can optionally include where each of the plurality of members can view the data on a unique electronic device.

In Example C6, the subject matter of any one of Examples C1-C5 can optionally include where the is data located in a cache that is separate from the social drive and an electronic device that communicated the metadata to the social drive.

In Example C7, the subject matter of any one of Examples C1-C6 can optionally include where a notification is sent to an owner of the data when the member requests the data.

In Example C8, the subject matter of any one of Examples C1-C7 can optionally include where access to the data is restricted by an owner of the data.

In Example A1, an electronic device can include a unifying data module configured to receive a request to share data, determine metadata for the data to be shared, communicate the metadata to a social drive, where the social drive is separate from the unifying data module and the data is not located on the social drive, and communicate the shared data to a member of the social drive when the member requests the data.

In Example, A2, the subject matter of Example A1 can optionally include where the data is located on an electronic device that includes the unifying data module.

In Example A3, the subject matter of any one of Examples A1-A2 can optionally include where the social drive includes a plurality of members and a notification is sent to each of the plurality of members when the metadata is communicated to the social drive

In Example A4, the subject matter of any one of Examples A1-A3 can optionally include where the plurality of members do not have access to the location of the data.

In Example A5, the subject matter of any one of Examples A1-A4 can optionally include where each of the plurality of members can view the data on a unique electronic device.

In Example A6, the subject matter of any one of Examples A1-A5 can optionally include where a notification is sent to an owner of the data when the member requests the data.

In Example A7, the subject matter of any one of Examples A1-A6 can optionally include where access to the data is restricted by an owner of the data.

In Example A8, the subject matter of any one of Examples A1-A7 can optionally include where the unifying data module is further configured to communicate the shared data to a cache that is separate from the unifying data module and the cache can communicate the shared data to the member when the unifying data module is not available.

Example M1 is a method including receiving, at an electronic device, a request to share data, determining metadata for the data to be shared, communicating the metadata to a social drive, where the social drive is separate from the electronic device and the data is not located on the social drive, and communicating the shared data to a member of the social drive when the member requests the data.

In Example M2, the subject matter of Example M1 can optionally include where the data is located on the electronic device.

In Example M3, the subject matter of any one of the Examples M1-M2 can optionally include where the data is located in a cache that is separate from the electronic device and the social drive.

In Example M4, the subject matter of any one of the Examples M1-M3 can optionally include where the social drive includes a plurality of members and a notification is sent to each of the plurality of members when the metadata is communicated to the social drive.

In Example M5, the subject matter of any one of the Examples M1-M4 can optionally include where the plurality of members do not have access to the location of the data.

In Example M6, the subject matter of any one of the Examples M1-M5 can optionally include where each of the plurality of members can view the data on a unique electronic device.

In Example M7, the subject matter of any one of the Examples M1-M6 can optionally include where a notification is sent to an owner of the data when the member requests the data.

In Example M8, the subject matter of any one of the Examples M1-M7 can optionally include where the data is located on the electronic device and the member of the social drive does not have access to the location of the data.

Example S1, is a system for sharing data using a social drive, the system including an integrity verification module configured for receiving, at an electronic device, a request to share data, determining metadata for the data to be shared, communicating the metadata to a social drive, where the social drive is separate from the electronic device and the data is not located on the social drive, and communicating the shared data to a member of the social drive when the member requests the data.

In Example S2, the subject matter of Example S1 can optionally include where the data is located on the electronic device and the member of the social drive does not have access to the location of the data.

In Example S3, the subject matter of Examples S1-S2 can optionally include where the data is located on the electronic device.

In Example S4, the subject matter of any one of the Examples S1-S3 can optionally include where the data is located in a cache that is separate from the electronic device and the social drive.

In Example S5, the subject matter of any one of the Examples S1-S4 can optionally include where the social drive includes a plurality of members and a notification is sent to each of the plurality of members when the metadata is communicated to the social drive.

In Example S6, the subject matter of any one of the Examples S1-S5 can optionally include where the plurality of members do not have access to the location of the data.

In Example S7, the subject matter of any one of the Examples S1-S6 can optionally include where each of the plurality of members can view the data on a unique electronic device.

In Example S8, the subject matter of any one of the Examples S11-S7 can optionally include where a notification is sent to an owner of the data when the member requests the data.

Example X1, is a machine-readable storage medium including machine-readable instructions to implement a method or realize an apparatus as in any one of the Examples A1-A8, or M1-M8. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions.

1-25. (canceled)

26. At least one machine-readable medium comprising one or more instructions that, when executed by at least one processor, cause the at least one processor to:
receive a request from a member of a social drive to view data;
determine metadata for the data, wherein the metadata is located on the social drive;
locate the data based on the determined metadata, wherein the data is not located on the social drive; and
communicate the data to the member of the social drive.

27. The at least one computer-readable medium of claim 26, wherein the data is located on an electronic device that communicated the metadata to the social drive.

28. The at least one computer-readable medium of claim 27, wherein the social drive includes a plurality of members and a notification was sent to each of the plurality of members when the metadata was communicated to the social drive.

29. The at least one computer-readable medium of claim 28, wherein the plurality of members do not have access to the location of the data.

30. The at least one computer-readable medium of claim 28, wherein each of the plurality of members can view the data on a unique electronic device.

31. The at least one computer-readable medium of claim 26, wherein the data located in a cache that is separate from the social drive and an electronic device that communicated the metadata to the social drive.

32. The at least one computer-readable medium of claim 26, wherein a notification is sent to an owner of the data when the member requests the data.

33. The at least one computer-readable medium of claim 26, wherein access to the data is restricted by an owner of the data.

34. An apparatus comprising:
a unifying data module configured to:
receive a request to share data;
determine metadata for the data to be shared;
communicate the metadata to a social drive, wherein the social drive is separate from the unifying data module and the data is not located on the social drive; and
communicate the shared data to a member of the social drive when the member requests the data.

35. The apparatus of claim 34, wherein the data is located on an electronic device that includes the unifying data module.

36. The apparatus of claim 34, wherein the social drive includes a plurality of members and a notification is sent to each of the plurality of members when the metadata is communicated to the social drive.

37. The apparatus of claim 36, wherein the plurality of members do not have access to the location of the data.

38. The apparatus of claim 36, wherein each of the plurality of members can view the data on a unique electronic device.

39. The apparatus of claim 34, wherein a notification is sent to an owner of the data when the member requests the data.

40. The apparatus of claim 34, wherein access to the data is restricted by an owner of the data.

41. The apparatus of claim 34, wherein the unifying data module is further configured to communicate the shared data to a cache that is separate from the unifying data module and the cache can communicate the shared data to the member when the unifying data module is not available.

42. A method comprising:
receiving, at an electronic device, a request to share data;
determining metadata for the data to be shared;
communicating the metadata to a social drive, wherein the social drive is separate from the electronic device and the data is not located on the social drive; and
communicating the shared data to a member of the social drive when the member requests the data.

43. The method of claim 41, wherein the data is located on the electronic device and the member of the social drive does not have access to the location of the data.

44. A system for sharing data using a social drive, the system comprising:
an integrity verification module configured for:
receiving, at an electronic device, a request to share data;
determining metadata for the data to be shared;
communicating the metadata to a social drive, wherein the social drive is separate from the electronic device and the data is not located on the social drive; and
communicating the shared data to a member of the social drive when the member requests the data.

45. The system of claim 44, wherein the data is located on the electronic device.

46. The system of claim 44, wherein the data is located in a cache that is separate from the electronic device and the social drive.

47. The system of claim 44, wherein the social drive includes a plurality of members and a notification is sent to each of the plurality of members when the metadata is communicated to the social drive.

48. The system of claim 47, wherein the plurality of members do not have access to the location of the data.

49. The system of claim 47, wherein each of the plurality of members can view the data on a unique electronic device.

50. The system of claim 44, wherein a notification is sent to an owner of the data when the member requests the data.
